(19) United States
(12) Patent Application Publication
(10) Pub. No.: US 2001/0035246 A1
(43) Pub. Date: Nov. 1, 2001

(54) Emergency tire traction device for improving traction of a wheel

(76) Inventors: Gabriel J. Wettlaufer, San Jose, CA (US); William T. Pritchard, Port Orchard, WA (US); David E. Walrath, Laramie, WY (US)

Correspondence Address: Emery L. Tracy, P.O. Box 1518, Boulder, CO, 80306, US

(21) Appl. No.: 09/836,498

(22) Filed: Apr. 17, 2001

Related U.S. Application Data
(60) Provisional application No. 60/198,700, filed on Apr. 20, 2000.

(51) Int. Cl. B60C 11/00

(52) U.S. Cl. 152/225 R

(57) ABSTRACT

An emergency system for improving the traction of a tire with the tire having an outer circumferential tread surface and an inner circumferential edge. The emergency system has at least one tire traction device having a substantially C-shaped cross-sectional configuration with at least a portion of the tire traction device positionable about at least a portion of the tread of the tire. A tensioning strap is positioned between the tire traction devices. An adjustable connecting strap is secured to each tire traction device and the tensioning strap wherein upon a tightening adjustment of each adjustable connecting strap, each tire traction device is releasably secured about at least a portion of the tread surface of the tire.

The present application is a continuation of pending provisional patent application Serial No. 60/198,700, filed on Apr. 20, 2000, entitled “Emergency Tire Traction Device”.

### BACKGROUND OF THE INVENTION

1. Field of the Invention

This invention relates generally to a device for providing additional traction to vehicle tires during low traction and emergency situations and, more particularly, it relates to a tire traction device for all types of vehicles which are lightweight, compact, easily installable, and low cost.

2. Description of the Prior Art

The tire traction of motor vehicles is important to ensure the safety of the vehicle occupants, other motorists, and pedestrians. Tire traction becomes of greatest concern when driving conditions are degraded or otherwise impaired by environmental factors such as rain, snow, and/or ice. For this reason, supplemental traction devices are necessary, and often essential, to improve traction and control of the motor vehicle.

In the past, there have been several attempts to solve the dilemma of impaired traction. One attempt to solve the problem is often referred to as studded tires. Studded tires are typically a seasonal solution requiring two sets of tires, i.e., one studded tire set and one regular traction set, and the labor expense to cycle between the sets depending on the season and/or conditions. Being applied seasonally suggests that the studded tires will also be used by the motorists on dry roads, which tends to damage the roads and tires and reduces the tire life.

Another attempted solution to improve tire traction is using tire chains. Tire chains are not seasonal and can be installed about and removed from the tire when desired. While this solution is more convenient that studded tires, the tire chains are expensive, heavy, and difficult to install about and remove from the tires.

Accordingly, there exists a need for an emergency tire traction device which is lightweight, compact, easily installed, and significantly lower priced than conventional tire traction improvement devices. Additionally, a need exists for an emergency tire traction device which improves the traction of a tire in adverse environments with minimal time delays in installation.

### SUMMARY

The present invention is a tire traction device for improving traction of a tire. The tire traction device comprises a main body having a first arm, a second arm, and a middle arm connecting the first arm to the second arm and means for securing the main body to the tire.

Additionally, the present invention includes an emergency system for improving the traction of a wheel. The wheel has a tire mounted on a rim. The tire has an outer circumferential tread surface and an inner circumferential edge with the inner circumferential edge contacting the rim of the tire. The emergency system comprises at least one tire traction device having a substantially C-shaped cross-sectional configuration with at least a portion of the tire traction device positionable about at least a portion of the tread surface of the tire. A tensioning strap is positioned between the tire traction devices. An adjustable connecting strap is secured to each tire traction device and the tensioning strap wherein upon a tightening adjustment of each adjustable connecting strap, each tire traction device is releasably secured about at least a portion of the tread surface of the tire.

The present invention further includes a method for improving the traction of a tire. The tire having a tread surface around an outer circumference of the tire and an inner edge about an inner circumference of the tire. The method comprises providing at least one substantially C-shaped tire traction device having a first arm, a second arm, and a connecting portion, positioning the first arm of the tire traction device over at least a portion of the tread surface of the tire, positioning the second arm of the tire traction device over the inner edge of the tire, connecting each tire traction device to each other tire traction device with an adjustable strap, and tightening each adjustable strap to secure each tire traction device to the tire.

### BRIEF DESCRIPTION OF THE DRAWINGS

FIG. 1 is a perspective view of an emergency tire traction device, constructed in accordance with the present invention;

FIG. 2 is an elevational end view of the emergency tire traction device of FIG. 1, constructed in accordance with the present invention;

FIG. 3 is an elevational side view of the emergency tire traction device of FIG. 1, constructed in accordance with the present invention;

FIG. 4 is a rear perspective view of a wheel having a tire and a rim with the wheel having the emergency tire traction device installed thereon; and

FIG. 5 is a front perspective view of the wheel having the emergency tire traction device installed thereon.

### DETAILED DESCRIPTION OF THE PREFERRED EMBODIMENTS

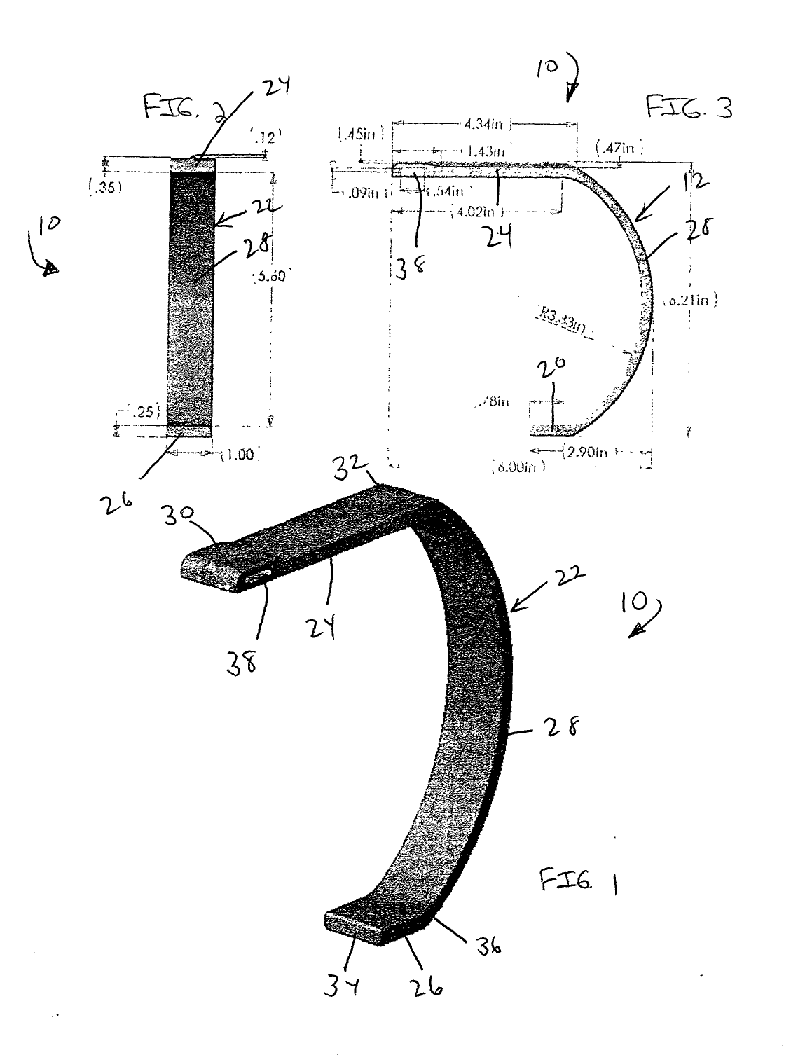

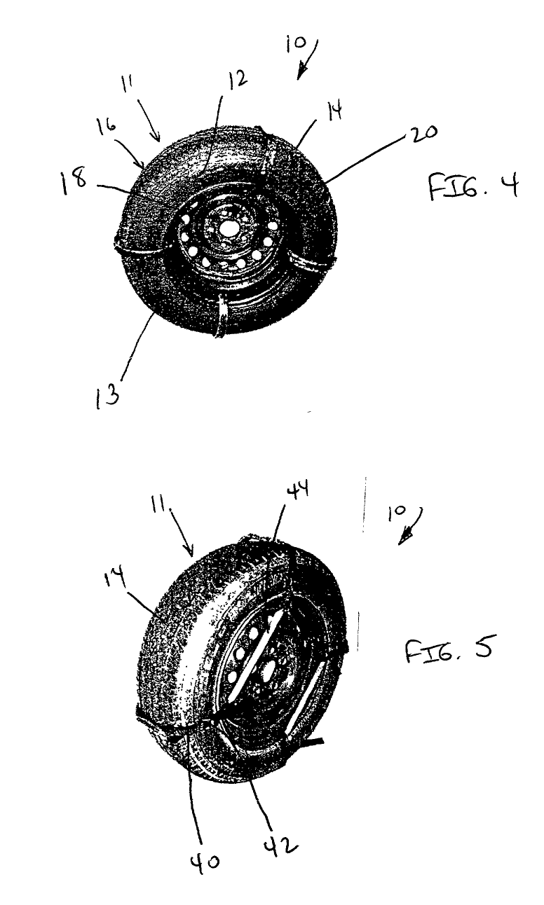

As illustrated in FIGS. 1-5, the present invention is an emergency tire traction device, indicated generally at 10, for improving the traction of a wheel assembly 11 on a vehicle (not shown). The wheel assembly 11 typically includes a tire 12 and a rim 13. The tire 12 has a tread surface 14 about an outer circumference 16 of the tire 12 and an inner edge 18 about an inner circumference 20 of the tire 12. The tire 12 is mounted to the rim 13 in a known manner such that the inner edge 18 of the tire 12 contacts the rim 13. The emergency tire traction device 10 of the present invention can be used on any type of tire 12 having any type of rim 13 for any type of vehicle including, but not limited to, automobiles, trucks, vans, tractors, all terrain vehicles, etc.

The emergency tire traction device 10 has a substantially C-shaped main body 22. The main body 22 is preferably constructed from either unreinforced or fiber-reinforced polymer having high performance characteristics formed through an injection molding process. The preferred polymer includes two components, polycarbonate and nylon 6, which exhibit the necessary high performance characteristics and meet the stress performance requirements which are necessary for use on the tire 12. It should be noted that while the main body 22 has been described as being constructed from a fiber-reinforced polymer formed through an injection molding process, it is within the scope of the present invention to construct the main body 22 from other materials including, but not limited to, other polymers, plastic, metal, aluminum, ceramic, etc, and to form the main body through other processes.

The main body 22 of the emergency tire traction device 10 has a first arm 24, a second arm 26 substantially parallel to the first arm 24, and a curved connecting portion 28 connected between the first arm 24 and the second arm 26. When positioned on the wheel assembly 11, the first arm 24 spans at least a portion of the tread surface 14 of the tire 12 to improve the traction of the tire 12 during adverse weather or environmental conditions. To this end, since the first arm 24 spans at least a portion of the tread surface 14 of the tire 12, the first arm 24 preferably has a first length greater than a second length of the second arm 26. It is within the scope of the present invention, however, to have the first length of the first arm 24 have a length less than or equal to the second length of the second arm 26. Actual installation and operation of the emergency tire traction device 10 on a wheel assembly 11 to improve traction will be described in further detail below.

The first arm 24 of the main body 22 has a first end 30 and a second end 32 with the second end 32 being connected to the curved connecting portion 28. The second arm 26 of the main body 22 has a first end 34 and a second end 36 with the second end 36 being connected to the curved connecting portion 28. As described above, the curved connecting portion 24 spaces the first arm 12 and the second arm 22 in a substantially parallel manner thereby forming the substantially C-shaped cross-sectional configuration of the main body 22.

As described above, the main body 22, including the first arm 24, the second arm 26, and the connecting portion 28, is preferably formed through an injection molding process thereby forming a unitary main body 22. It is within the scope of the present invention, however, to construct the first arm 24, the second arm 26, and the connecting portion 28 separately and then connect the first arm 24 to the connecting portion 28 and the second arm 26 to the connecting portion 28.

The first end 30 of the first arm 24 has an aperture 38 for receiving a webbing strap 40 having a length of approximately twelve (12″) inches. The webbing straps 40 are constructed and designed to maintain each emergency tire traction device 10 to the wheel assembly 11 and about at least a portion of the tread surface 14 of the tire 12 and link multiple emergency tire traction devices 10 together about the wheel assembly 11, as illustrated in FIGS. 4 and 5. Each webbing strap 40 is preferably constructed from a nylon material and is sewn or otherwise secured to a buckle 32 which allows the length of the webbing strap 40 to be lengthened or shortened depending on the size, i.e., diameter and width, of the wheel assembly 11 and the tire 12.

In the preferred embodiment, a tensioning strap 44 is provided to releasably secure each webbing strap 40 to each other webbing strap 40 and, thus, firmly secure each emergency tire traction device 10 to the wheel assembly 11. The ends of the tensioning strap 44 are sewn are otherwise connected together to form a substantial loop with each webbing strap 40 being looped through the tensioning strap 44.

The tensioning strap 44 is preferably constructed from a strip of nylon material, similar to the webbing strap 40, having a length of approximately ten (10″) inches. It should be noted that while both the webbing straps 40 and the tensioning strap 44 are described as being constructed from a nylon material, it is within the scope of the present invention to construct the webbing straps 40 and/or the tensioning strap 44 from other materials including, but not limited, to elastic materials.

The installation and operation of the emergency tire traction devices 10 will now be described in detail. First, each emergency tire traction device 10 is positioned on the wheel assembly 11 with at least a portion of the first arm 24 being positioned over the tread surface 14 of the tire 12 and the second arm 26 being positioned over the rim 13 adjacent the inner edge 18 of the tire 12. The inventors of the present application have determined that positioning at least four (4) emergency tire traction devices 10 in a spaced manner about the wheel assembly 11 offers optimum traction with minimal expense. It should be noted, however, that positioning more than four (4) emergency tire traction devices 10 about the wheel assembly 11 or positioning less than four (4) emergency tire traction devices 10 about the wheel assembly 11 is within the scope of the present invention.

Next, each webbing strap 40 is looped about the tensioning strap 44 to connect the multiple emergency tire traction devices 10 together. Each webbing strap 40 is then tightened via the buckle 42 to releasably securely maintain each emergency tire traction device 10 to the wheel assembly 11. The emergency tire traction devices 10 are now installed about the wheel assembly 11 and re ready to use to assist in maintaining and improving traction of the wheel assembly 11 during adverse whether conditions.

The emergency tire traction device 10 of the present invention is a novel approach to increasing the traction of tires 12 in adverse environmental conditions. The emergency tire traction device 10 is lightweight weighing only approximately 1.67 pounds. Furthermore, the emergency tire traction device 10 can be stored in a container (not shown) having dimensions of approximately nine (9″) inches by approximately seven and one-half (7½″) inches by approximately four (4″) inches.

The design of the emergency tire traction device 10 enables emergency use of the emergency tire traction device 10 use with minimal installation time. Furthermore, the emergency tire traction device 10 is lightweight, compact, easily installed, and inexpensive, while accommodating a wide variety of wheel assemblies 11 having different diameters and widths.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A tire traction device for improving traction of a tire, the tire traction device comprising:
a main body having a first arm, a second arm, and a middle arm connecting the first arm to the second arm;
means for securing the main body to the tire.

2. The tire traction device of claim 1 wherein the main body is constructed from a fiber-reinforced polymer.

3. The tire traction device of claim 1 wherein the first arm is substantially parallel to the second arm.

4. The tire traction device of claim 1 wherein the middle arm has a substantially curved cross-sectional configuration.

5. The tire traction device of claim 1 wherein the first arm has a first end and a second end, the second end of the first arm being connected to the middle arm, and further comprising:
an aperture formed in the first end of the first arm.

6. The tire traction device of claim 5 wherein the means for securing is a webbing strap receivable within the aperture, the webbing strap having an adjusting mechanism for releasably adjusting the length of the webbing strap.

7. The tire traction device of claim 6 wherein the adjusting mechanism is a buckle, the webbing strap being secured to the buckle such that the length of the webbing strap is adjustable.

8. The tire traction device of claim 6 wherein the means for securing further comprises a tensioning strap positionable adjacent the tire, the tensioning strap releasably securable to the webbing strap.

9. The tire traction device of claim 8 wherein the tensioning strap is a continuous loop, further wherein each webbing strap is looped through the continuous loop tensioning strap.

10. The tire traction device of claim 8 wherein the webbing strap and tensioning strap are constructed from a nylon material.

11. An emergency system for improving the traction of a wheel, the wheel having a tire mounted on a rim, the tire having an outer circumferential tread surface and an inner circumferential edge with the inner circumferential edge contacting the rim, the emergency system comprising:
at least one tire traction device having a substantially C-shaped cross-sectional configuration, at least a portion of the tire traction device positionable about at least a portion of the outer circumferential tread surface of the tire;
a tensioning strap positioned between the tire traction devices; and
an adjustable connecting strap secured to each tire traction device and the tensioning strap;
wherein upon a tightening adjustment of each adjustable connecting strap, each tire traction device is releasably secured about the wheel.

12. The emergency system of claim 11 wherein each tire traction device has a first arm, a second arm, and a curved portion connecting the first arm to the second arm, the first arm positionable over at least a portion of the tread surface of the tire and the second arm positionable over the rim nearingly adjacent the inner circumferential edge of the tire.

13. The emergency system of claim 11 wherein the first arm is substantially parallel to the second arm.

14. The emergency system of claim 11 and further comprising:
an aperture formed in the first arm for receiving the connecting strap.

15. The emergency system of claim 11 and further comprising:
at least four tire traction devices positionable in a spaced manner about the wheel.

16. A method for improving the traction of a tire, the tire having a tread surface around an outer circumference of the tire and an inner edge about an inner circumference of the tire, the method comprising:
providing at least one substantially C-shaped tire traction device having a first arm, a second arm, and a connecting portion;
positioning the first arm of the tire traction device over at least a portion of the tread surface of the tire;
positioning the second arm of the tire traction device over the inner edge of the tire;
connecting each tire traction device to each other tire traction device with an adjustable strap; and
tightening each adjustable strap to secure each tire traction device to the tire.

17. The method of claim 16 and further comprising:
forming the connecting portion in a substantially curved cross-sectional configuration.

18. The method of claim 16 and further comprising:
positioning at least four tire traction devices in a spaced manner about the tire.

19. The method of claim 16 and further comprising:
securing an adjustable strap to each tire traction device; and
securing a tensioning strap to the adjustable straps.

20. The method of claim 19 and further comprising:
adjusting each adjustable strap to move the tensioning strap into a taut manner.
